(19) United States
(12) Patent Application Publication
(10) Pub. No.: US 2023/0319177 A1
(43) Pub. Date: Oct. 5, 2023

(54) VISUAL STATUS NOTIFICATION ON EDGE OF DISPLAY

(71) Applicant: Google LLC, Mountain View, CA (US)

(72) Inventors: Tim Wantland, Bellevue, WA (US); Vignesh Sachidanandam, Redwood City, CA (US)

(21) Appl. No.: 18/041,741

(22) PCT Filed: Aug. 19, 2020
(86) PCT No.: PCT/US2020/046972

§ 371 Date: Feb. 15, 2023

(51) Int. Cl. H04M 1/72409; H04M 1/72466

(52) U.S. Cl. CPC H04M 1/72409; H04M 1/72466

(57) ABSTRACT

The application is directed to edge lighting for computing device (200)s (200). The computing device (200) may include a display including a first portion (280) and a second portion (270), where the first portion (280) includes a substantial portion of a perimeter of the display and excludes the second portion (270) of the display. The computing device (200) may also include one or more processors (210) configured to determine a change in a status of the computing device (200), and determine, based on the change in the status, a visual notification (306). The one or more processors (210) may also be configured to interface with the first portion (280) of the display to output, based on the visual notification, a pattern of light (308).

### BACKGROUND

Computing devices often enable a variety of notifications that indicate a status change of the computing device. For example, a cellular phone (including a so-called “smartphone”) may issue a notification indicating that a cellular interface or other wireless interface has received an incoming call using a vibration, a ring tone or other audible alert, a visual message or other graphical element, etc. The cellular phone may issue similar notifications indicating that the cellular interface and/or the other wireless interface has received a text message.

However, the cellular device may issue inconsistent notifications for other functionalities of the cellular phone. For example, the cellular phone may include near field communication (NFC) interfaces, personal area network (PAN) interfaces (such as a Bluetooth® interface), and the like by which the cellular phone may interact with other computing devices, but present limited or no notifications when such interfaces detect other compatible devices, such as a wireless speaker (including a smart speaker or smart personal assistant speaker), a display (such as a television, a smart television, a smart display, a personal assistant display device, etc.), a smart watch, smart glasses, home automation devices (including smart lights, smart thermostats, automated blinds, smart plugs, etc.), cameras, and the like. As such, users of cellular phones and other electronic devices may not use the cellular phone to interface with other devices or fully understand how cellular phones may be used given die inconsistent notifications between different functionalities of the cellular phone.

### SUMMARY

In general, this disclosure describes a unified notification system that utilizes an edge lighting component of a computing device to output, based on visual notifications determined responsive to a change in status of the computing device, patterns of light indicative of the current status of the computing device (e.g., in response to user input, change in location, change in other devices proximate to the computing device, change in sensors of the computing device, etc.). The visual notification may represent the different patterns of light (including different colors, animations, etc.) and may configure the edge lighting component to output the patterns of light -using pixels at different locations along the edge lighting component. For example, if a camera of the computing device is on, the edge lighting component may output a particular color, pattern, or animation at a location near or adjacent to the camera. As another example, if a user provides input to change a volume level of a speaker of the computing device, the edge lighting component may output a change in a size of a particular color that is indicative of a current volume level relative to a maximum volume level of the speaker (which may generally refer to a speaker of the computing device or a speaker connected to the computing device either wirelessly, such as wireless speakers and/or wireless headphones, or via wired connection, such as wired speakers and/or wired headphones).

In this way, techniques of this disclosure may provide additional information about a computing device in an intuitive and unified manner (using edge lighting to signify each status change of the computing device). The unified edge lighting may allow a user of the computing device to more quickly identify status changes of the computing device (compared to computing devices that feature a non-uniform status notification system) without potentially resorting to inspection of various system level configuration parameters. As such, various aspects of the edge lighting techniques may reduce the number of user inputs required to perform tasks or determine a current state of the computing device, which may reduce consumption of computing resources (such as processor cycles, memory space, memory bus bandwidth) and thereby potentially improve power efficiency of the computing device itself.

In one example, various aspects of the techniques are directed to a method comprising: determining, by one or more processors of a computing device, a change in a status of the computing device; determining, by the one or more processors of the computing device and based on the change in the status, a visual notification; and interfacing, by the one or more processors of the computing device, with a first portion of a display of the computing device to output, based on the visual notification, a pattern of light, the display including the first portion and a second portion, the first portion including a substantial portion of the perimeter of the display, and excluding the perimeter of a second portion of the display.

In another example, various aspects of the techniques are directed to a computing device comprising: a display including a first portion and a second portion, wherein the first portion includes a substantial portion of a perimeter of the display and excludes the second portion of the display; one or more processors configured to: determine a change in a status of the computing device; determine, based on the change in the status, a visual notification; and interface with the first portion of the display to output, based on the visual notification, a pattern of light.

In another example, various aspects of the techniques are directed to a non-transitory computer-readable storage medium having stored thereon instructions that, when executed, cause one or more processors to: determine a change in a status of the computing device; determine, based on the change in the status, a visual notification; and interface with a first portion of a display of the computing device to output, based on the visual notification, a pattern of light, the display including the first portion and a second portion, the first portion including a substantial portion of a perimeter of the display and excluding the second portion of the display.

### BRIEF DESCRIPTION OF DRAWINGS

FIG. 1 is a conceptual diagram illustrating an example communications system configured to provide a pattern of light on the perimeter of a device, in accordance with one or more techniques of the present disclosure.

FIG. 2 is a block diagram illustrating an example computing device that is configured to provide visual communication via edge lighting, in accordance with one or more aspects of the present disclosure.

FIG. 3 is a flow diagram illustrating example operations of a computing device for providing visual communication via edge lighting, in accordance with one or more aspects of the present disclosure.

FIGS. 4A-4D are conceptual diagrams illustrating example computing devices for providing visual communication via edge lighting, in accordance with various techniques of this disclosure.

### DETAILED DESCRIPTION

In general, this disclosure describes a computing device configured to provide visual communication, via edge lighting, to a user about a status change of the computing device. The computing device may include a display along the perimeter of the computing device, such as around a central display. The computing device may change a status, such as in response to receiving an input (e.g., touch input, voice input, button input, motion input, touchless gesture input, remote device input, etc.). To indicate the status change, the computing device may determine a visual notification. The computing device may display, based on the visual notification, a pattern of light on the display along the perimeter of the computing device. In some examples, the computing device may configure the display to output, based on the visual notification, distinct segments of light along a direction from which the computing device receives the input to indicate the status change occurring responsive to the input.

The computing device may activate a portion of pixels in a perimeter of the display to output edge lighting that provides visual communication to the user. The portion of the pixels of the display (which is another way to refer to a first portion of the display) may substantially include the perimeter of the display and may exclude a second portion of the pixels of the display (which is another way to refer to a second portion of the display) that do not include the perimeter of the display. The perimeter of the display may refer to a band of continuous or non-contiguous pixels that substantially surround the outer edges of the display (such as a contiguous band of pixels that surrounds more than 50% or some higher percentage of the perimeter of the display, where the band may be a number of pixels wide but less than some percentage of the overall pixels of the display, e.g., 1%, 5%. 10%, 20% or 30%—or possibly higher percentages but below 50%—of all the available pixels of the display). The edge lighting may include groups of one or more activated pixels that are distinguishable from other groups of one or more pixels by varied brightness or colors. The computing device may change the activation of the groups of pixels over time, causing an animation, such as a group of pixels blinking.

The techniques disclosed herein may increase the efficiency of the computing device and reduce user confusion about interactions with the computing device. As computing devices increase in complexity, the computing devices require a way by which to facilitate user understanding regarding functionality provided by the computing device. Rather than utilize different and varied ways to interface with the user (e.g., visual notifications such as alert messages or status alerts, auditory notifications such as chimes or alerts, haptic notifications such as vibrations, etc.), the computing device may offer a consistent notification system. Instead of different applications and features on a device employing random ways, or completely lacking ways, of communicating with the user about functionalities, the computing device outputs the pattern of light as a unified notification system.

Moreover, rather than the computing device needlessly consuming resources (e.g., bandwidth, memory, processing power, etc.) by performing status changes the user does not desire, the computing device may be configured to perform status changes more efficiently (in terms of computing resources). In some cases, the computing device may output, based on visual notifications, patterns of light to communicate to the user about how the computing device is using resources (e.g., processor cycles, memory, memory bus bandwidth, etc.). For example, without what may be referred to as a “visual language,” the computing device may drain battery power by scanning for devices via personal area networks (PAN) without the user's knowledge. In contrast, with the so-called visual language, the computing device may communicate to the user that the computing device is performing, a scan by interfacing with the display to output the pattern of light, allowing the user to configure the computing device to turn off the PAN. In other words, the computing device enables the user to configure the computing device to better accommodate the user's preferences. As a result, the visual language may facilitate elimination of needless consumption of computing resources.

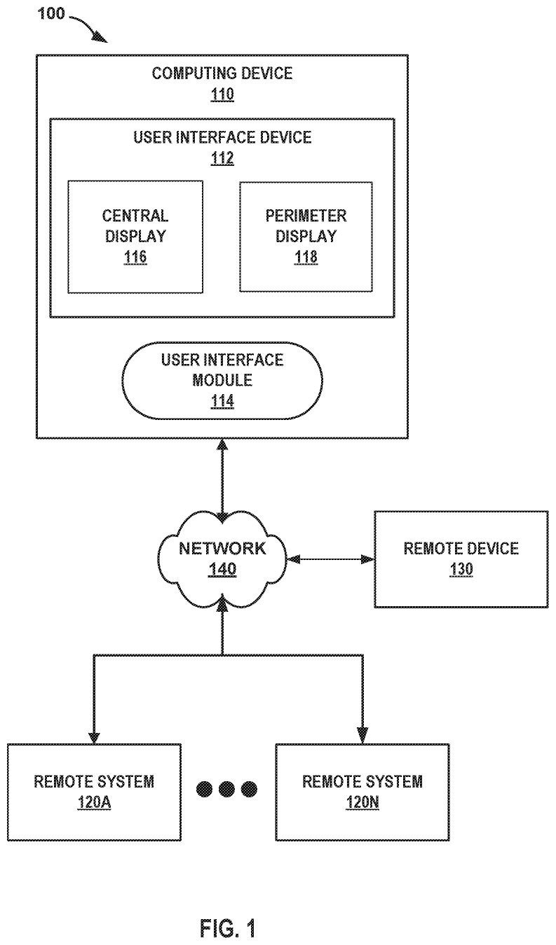

FIG. 1 is a conceptual diagram illustrating an example communications system configured to provide a pattern of light on the perimeter of a device, in accordance with one or more techniques of the present disclosure. As shown in FIG. 1, system 100 includes computing device 110, remote device 130, and remote systems 120A-120N (hereafter “remote systems 120”). Computing device 110 may communicate with remote device 130 and remote systems 120 via network 140, or directly, to provide the pattern of light on perimeter display 118, the perimeter of computing device 110.

Examples of computing device 110 may include, but are not limited to, portable, mobile, or other devices, such as mobile phones (including smartphones), laptop computers, desktop computers, tablet computers, smart television platforms, server computers, mainframes, and the like. For instance, in the example of FIG. 1, computing device 110 may be a wearable computing device, such as a smartwatch.

Computing device 110, as shown in the example of FIG. 1, includes user interface device 112. User interface device 112 of computing device 110 may be configured to function as an input device and/or an output device for computing device 110. User interface device 112 may be implemented using various technologies. For instance, user interface device 112 may be configured to receive tactile, auditory, visual, touchless gesture, motion, and/or remote-device input. Examples of input devices include a presence-sensitive display, a presence-sensitive or touch-sensitive input device, a mouse, a keyboard, a voice responsive system, a camera, a microphone, a button, a switch, a radar, or any other type of device for detecting a signal from an environment of computing device 110, such as by a user or remote device 130. In some examples, a presence-sensitive display includes a touch-sensitive or presence-sensitive input screen, such as a resistive touchscreen, a surface acoustic wave touchscreen, a capacitive touchscreen, a projective capacitance touchscreen, or another presence-sensitive technology. That is, user interface device 112 may include a presence-sensitive device that may receive tactile input from a user of computing device 110.

User interface device 112 may receive indications of the tactile input by detecting one or more touch gestures from the user(e.g., a tap, a swipe, a hold, a button press, etc.). Examples of input devices may further include sensors to detect motion (e.g., an accelerometer, a gyroscope, etc.), location (e.g., a GPS, a barometer, a magnetometer, etc.), touchless gestures (e.g., radio wave transmission receivers, etc.), or other devices (e.g., infrared transmission receivers)

User interface device 112 may additionally or alternatively be configured to function as an output device by providing output to a user using tactile, auditory, or visual stimuli. Examples of output devices include a sound card, a video graphics adapter card, or any of one or more display devices, such as a liquid crystal display (LCD), dot matrix display, light emitting diode (LED) display, micro light emitting diode (micro-LED) display, quantum light emitting diode (QLED) display, organic light emitting diode (OLED) display, e-ink, or similar monochrome or color display capable of outputting visible information to a user of computing device 110. Additional examples of an output device include a speaker, a liquid crystal display (LCD), or other device that can generate intelligible output to a user.

For instance, user interface device 112 may present output to a user of computing device 110 as a graphical user interface that may be associated with functionality provided by computing device 110. In this way, user interface device 112 may present various user interfaces of applications executing at or accessible by computing device 110 (e.g., an electronic message application, an Internet browser application, etc.). A user of computing device 110 may interact with a respective user interface of an application to cause computing device 110 to perform operations relating to a function.

In some examples, user interface device 112 of computing device 110 may detect two-dimensional and/or three-dimensional gestures as input from a user of computing device 110. For instance, a sensor of user interface device 112 may detect the user's movement (e.g., moving a hand, an arm, a pen, a stylus) within a threshold distance of the sensor of user interface device 112. User interface device 112 may determine a two-dimensional or three-dimensional vector representation of the movement and correlate the vector representation to a gesture input (e.g., a hand-wave, a pinch, a clap, a pen stroke) that has multiple dimensions. In other words, user interface device 112 may, in some examples, detect a multidimensional gesture without requiring the user to gesture at or near a screen or surface at Which user interface device 112 outputs information for display. Instead, user interface device 112 may detect a multidimensional gesture performed at or near a sensor which may or may not be located near the screen or surface at which user interface device 112 outputs information for display.

In the example of FIG. 1, computing device 110 includes user interface module 114. User interface module 114 may perform one or more operations described herein using hardware, software, firmware, or a mixture thereof residing within and/or executing at computing device 110. Computing device 110 may execute user interface module 114 with one processor or with multiple processors. In some examples, computing device 110 may execute user interface module 114 as a virtual machine executing on underlying hardware. User interface module 114 may execute as one or more services of an operating system or computing platform or may execute as one or more executable programs at an application layer of a computing platform.

User interface module 114, as shown in the example of FIG. 1, may be operable by computing device 110 to perform one or more functions, such as receive input and send indications of such input to other components associated with computing device 110. User interface module 114 may also receive data from components associated with computing device 110. Using the data received, user interface module 114 may cause other components associated with computing device 110, such as user interface device 112, to provide output based on the received data. For instance, user interface module 114 may receive data to display a GUI.

Remote systems 120 represent any remote computing systems, such as one or more desktop computers, laptop computers, mainframes, servers, cloud computing systems, etc., that are configured to store and/or manage data used by computing device 110. For example, remote systems 120 may include web servers, database management systems, and the like that are accessible via network 140.

Remote device 130 may be any additional computing device capable of communicating with computing device 110 via network 140 or directly. Examples of remote device 130 may include, but are not limited to, portable, mobile, or other devices, such as mobile phones (including smartphones), laptop computers, desktop computers, tablet computers, smart television platforms, server computers, mainframes, and the like. For instance, in the example of FIG. 1, remote device 130 may be a wearable computing device, such as a smartwatch.

Computing device 110 may have diverse or obscure ways of displaying notifications. Computing device 110 may notify a user of a text message via a banner. Computing device 110 may notify a user of a camera taking a picture via a shutter sound. Computing device 110 may provide an indication of a changing state within a nested menu, such as a list of configuration parameters. Computing device 110 may notify a user of an unsuccessful facial recognition attempt by a vibration.

Computing device 110 may not provide much if any indication of certain changing states. For example, computing device 110 typically does not indicate the frequency of wireless scanning. Computing device 110 may, as another example, not indicate reception of a signal of a touchless gesture (e.g., detected via radar or other forms of wireless gesture detection). Computing device 110 may not indicate a status change that is due to a motion (e.g., turning computing device 110 facedown). In these instances where computing device 110 may not provide much if any indication of certain changing states, computing device 110 may expend resources performing various activities (such as facial recognition, keyword detection, proximity detection, companion device detection, and other activities that are transparent or otherwise not actively communicated to the user) that the user may not desire, thereby needlessly expending computing resources (such as power, processor cycles, memory, memory bandwidth, etc.

Computing device 110 may routinely or periodically (or in some instances constantly or in various contexts, such as when connected to a particular wireless network) scan a network, such as network 140, to detect a companion device, such as remote device 130, and thereby interface with remote device 130. A signal from remote device 130 may represent a form of input to computing device 110. Computing device 110 may not be configured to alert the user of the scan or other transparent activity other than by way of settings or other configuration parameters that may be difficult to find in nested menus that may present such settings in current operating systems.

In accordance with one or more techniques of this disclosure, computing device 110 may be configured to provide unified and consistent visual notifications, via output of edge lighting, to a user about a status change of computing device 110. User interface device 112 may include perimeter display 118 that surrounds central display 116, where perimeter display 118 may present different patterns of light to notify the user, in a consistent way, regarding status changes of computing device 110. A status change of computing device 110 may result from, for example, an input such as a touch input, a voice input, a button input, a motion input, a touchless gesture input, a remote device input. To indicate the status change, computing device 110 may first determine a visual notification. Computing device 110 may then interface with the perimeter display 118 to output, based on the visual notification, a pattern of light.

When outputting the pattern of light, computing device 110 may interface with the perimeter display to activate, based on the visual notification representative of the pattern of light, pixels in perimeter display 118 so as to output the pattern of light. Perimeter display 118 may include groups of one or more activated pixels that are distinguishable from other groups of one or more pixels by varied brightness and/or colors. Computing device 110 may change the activation of the groups of pixels over time, causing an animation, such as the groups of pixels blinking, glowing, pulsing, flashing, changing in intensity or luminance, changing color changing patterns over time, etc.

In operation, user interface device 112 may include central display 116 and perimeter display 118. Perimeter display 118 (which may represent a first portion of display 116/118) may substantially surround central display 116 (which may represent a second portion of display 116/118) and as such may exclude central display 116. Perimeter display 118 may substantially surround central display 116 in that perimeter display 118 may include a band of continuous or non-contiguous pixels that substantially surround the outer edges of display 116/118. Perimeter display 118 may refer to a band of continuous or non-contiguous pixels that substantially surround the outer edges of display 116/118 (such as a contiguous band of pixels that surrounds more than 50% or some higher percentage of the perimeter of display 116/118, where the band may be a number of one or more pixels wide but less than some percentage of the overall pixels of the display, e.g., 1%, 5%, 10%, 20% or 30% but less than 50%—possibly lower percentages—of all the available pixels of display 116/118). The edge lighting may include groups of one or more activated pixels that are distinguishable from other groups of one or more pixels by varied brightness or colors.

In some examples, central display 116 and perimeter display 118 may be different portions of a single display. In other examples, central display 116 and perimeter display 118 may represent separate displays. Perimeter display 118 may be any of various widths (e.g., 3 pixels, 4 pixels, etc.). In some examples, central display 116 and perimeter display 118 may be on an equal plane (i.e., central display 116 and perimeter display 118 may be on a frontal face of computing device 110). In other examples, central display 116 and perimeter display 118 may be on different planes, where central display 116 may be on a frontal face of computing device 110, and perimeter display 118 may be on an edge of computing device 110 (e.g., central display 116 may be at a right angle, an acute angle, an obtuse angle, or any non-zero angle relative to perimeter display 118). User interface device 112 may present various user interfaces of applications via central display 116. User interface device 112 may output a pattern of light as edge lighting via perimeter display 118.

Computing device 110 may output, via perimeter display 118, a pattern of light in response to a status change of computing device 110. In some cases, the status change may result from an activation of one or more of a variety of sensors of user interface device 112. User interface device 112 may receive an indication of an input from sensors including a microphone, a camera, a radar, buttons, etc. Accordingly, the input may include tactile, auditory, visual, motion, radio wave transmission input, or any other input received by computing device 110 (which is assumed in this example to represent a cellular handset, such as a smartphone or other mobile computing device).

User interface device 112 may detect input from a user or from another device, such as remote systems 120 or remote device 130. User interface device 112 may detect local input, such as a button press, or ambient input, such as an ultrawideband (UWB) signal. User interface module 114 may process the input to determine a user command or as indication of a future user command, and responsive to detecting the input perform a corresponding process (such as begin a pairing process with remote device 130, activate central display 116, when the user is detected as being within viewing distance of computing device 110, activate a microphone, camera or other sensor, etc.). In other cases, the status change may not result from an activation of a sensor. The status change may result from an internal process or an execution of a predetermined task. Responsive to the internal process or the execution of the predetermined task, computing device 110 may perform one or more of the foregoing operations.

Performing the operation may change the status of computing device 110. User interface module 114 may initiate execution of a command such as taking a picture or increasing an audio volume. User interface module 114 may determine that computing device 110 should enter a new performance mode, such as a recording mode of a discovery mode. For example, in the recording mode, computing device 110 may activate a microphone to receive, store, and/or analyze audible input. As another example, in the discovery mode, computing device 110 may indicate a functionality of computing device 110, such as button available for pressing, a microphone available for capturing audio (such as speech), activation of pairing to remote device 130, etc.

Computing device 110 may indicate the status change by first determining a visual notification representative of the status change. User interface module 114 may determine that the status change is relevant to the user. User interface module 114 may interface with perimeter display 118 to output, based on the visual notification, the pattern of light to alert the user of the status change. User interface module 114 may further indicate control sensitivity on computing device 110. By outputting the pattern of light identified by the visual notification, user interface module 114 may offer discoverability of functionality as well as feedback to the user. User interface module 114 may output, based on the visual notification, the pattern of light so as to proactively assist the user in discovering potentially unknown or misconfigured functionality.

User interface module 114 may determine the visual notification and interface with perimeter display 118 to activate the pixels on perimeter display 118 with consistency across applications on computing device 110. In other words, user interface module 114 may enable a clear indication for a variety of status changes (which may refer to different functionalities that the user may have previously configured and forgotten, were default configuration with which the user has no desire to interact or enable, were misconfigured and for which the user has no desire to enable, etc.). User interface module 114 may provide such indications of status changes at a system level instead of at an application level, although user interface module 114 may alert the user to application level status changes as well using various aspects of the edge lighting techniques described in this disclosure.

In some cases, user interface module 114 may signal the status change via output, based on visual notification, of a pattern of light without words or icons. Instead of words or icons, user interface device 112 may interface with perimeter display 118 to output, based on the visual notification, the pattern of light. User interface module 114 may configure perimeter display 118 to activate a variety of pixels of perimeter display 118 to represent a variety of patterns of light that alert the user to various functionalities or other capabilities of computing device 110. In some cases, user interface module 114 may activate all the pixels on perimeter display 118. In other cases, user interface module 114 may activate a portion of the pixels on perimeter display 118. User interface module 114 may activate groups of pixels with variations in brightness and/or color.

User interface module 114 may determine a location of one or more groups of activated pixels to align with a location on computing device 110 or to indicate a direction from which computing device 110 received the input. In some cases, user interface module 114 may determine a dynamic variation in the activation of pixels over time, such that perimeter display 118 outputs an animation of the pattern of light. In other cases, user interface module 114 may determine a static activation of pixels.

The pattern of light may give feedback to the user about interactions by the user with computing device 110. For example, when the user presses a volume button (whether the volume button is a physical or a virtual button) to increase the volume of the audio output of computing device 110, perimeter display 118 may output a segment of light near the volume button that grows in length in proportion to the volume relative to a maximum volume level. As another example, when the user takes a photo using a camera app, perimeter display 118 may output a light along the entire perimeter display 118 or at a location proximate to the camera sensor.

In addition, the pattern of light may give feedback to die user about interactions between computing device 110 and another device, like remote device 130, via ambient intelligence. For example, computing device 110 may discover remote device 130 nearby, such as via PAN or UWB, and perimeter display 118 may output a segment of light along a portion of the perimeter corresponding to the direction of remote device 130. As another example, computing device 110 may be a smart TV that discovers two remote controls, and perimeter display 118 of the smart TV may output two segments of light along two portions of perimeter display 118 indicating respective directions of the two remote controls.

In some cases, user interface module 114 may determine that a pattern of pixel activations should contain groups of pixels varying in brightness of output, varying in color of output, or varying in activation and inactivation. For example, user interface module 114 may determine the location of the varied groups of the pattern (in the form of the visual notification representative of the varied groups of the pattern), such as aligning with an input device or indicating the direction of remote device 130 or a remote gesture. As another example, user interface module 114 may determine a change in pixel activations over time, resulting in an animation such as a flash or a change in size of a group of activated pixels. In other cases, user interface module 114 may not distinguish groups of pixels with unique variations. In such cases, user interface module 114 may determine a pattern of uniform pixel activations of a single intensity and color.

User interface module 114 may output the pattern of light on perimeter display 118. Perimeter display 118 may contain a plurality of pixels to produce the pattern of light. Perimeter display 118 may have different pixels activated at different times to output segments of lights of varying lengths, brightness, color, etc. Perimeter display 118 may have inactive pixels at times of no visual communication or at dark segments in the pattern of light.

The techniques disclosed herein may promote efficient user interactions with computing device 110. The common design implementation of edge lighting may reduce user confusion and frustration about the increasing complexity of devices. Edge lighting may enable symbiotic hardware and software design to produce intuitive interaction patterns. Computing device 110 may provide feedback via such edge lighting, enabling the user to use touchless gestures more efficiently or avoid using unwanted touchless gestures. Computing device 110 may provide discoverability guidance via edge lighting, enabling the user to more efficiently interact with less common features and thereby promote adoption of such features. Computing device 110 may provide 360-degree situational awareness to the user due to perimeter display 118 encompassing, in some examples, the entirety of central display 116. In this way, Edge lighting may enhance the user experience of computing device 110 by providing a mode of consistent visual communication.

Moreover, computing device 110 may use the visual communication of edge lighting to enable the user to discover modes of operation of computing device 110 that the user does not desire and thereby allow the user to disable various actions performed during these modes of operation. Computing device 110 may avoid unnecessarily depleting energy, memory, or computational resources by a clear way of communication to the user, thereby enabling computing device 110 itself to operate more efficiently.

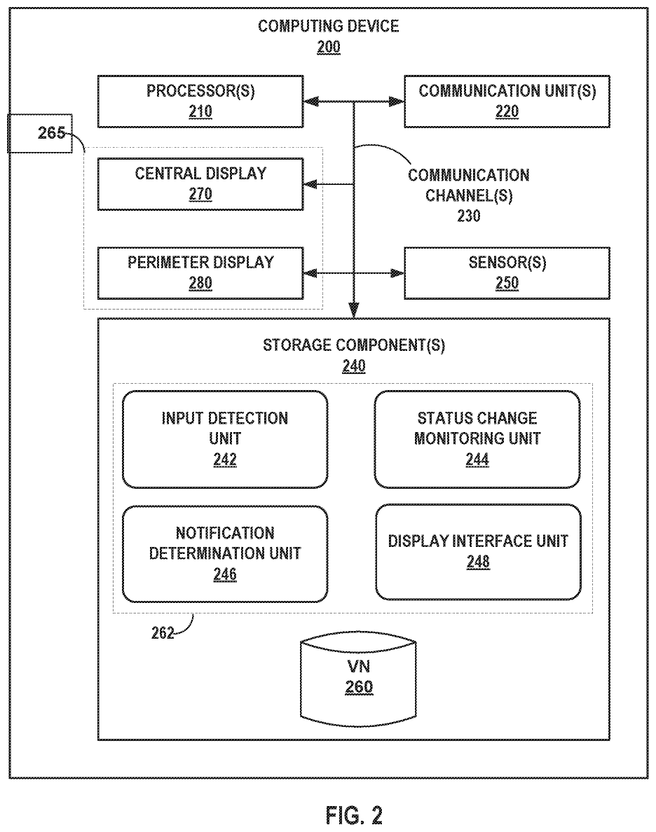

FIG. 2 is a block diagram illustrating an example computing device that is configured to provide visual communication via edge lighting about a status change of the example computing device, in accordance with one or more aspects of the present disclosure. Computing device 200 of FIG. 2 is described below as an example of computing device 110 of FIG. 1. FIG. 2 illustrates only one particular example of computing device 200, and many other examples of computing device 200 may be used in other instances and may include a subset of the components included in computing device 200 or may include additional components not shown in FIG. 2.

As shown in the example of FIG. 2, computing device 200 includes one or more processors 210, one or more communication unit(s) 220, one or more sensor(s) 250, one or more storage component(s) 240, central display 270, and perimeter display 280. Storage component(s) 240 of computing device 200 include user interface module 262 and visual notifications (VN) 260. User interface module 262 may be the same as or substantially similar to user interface module 114 of FIG. 1. User interface module 262 includes input detection unit 242, status change monitoring unit 244, notification determination unit 246, and display interface unit 248.

Communication channel(s) 230 interconnect each of the components 210, 220, 240, 250, 270, and 280 for inter-component communications (physically, communicatively, and/or operatively). In some examples, communication channel(s) 230 may include a system bus, a network connection, an inter-process communication data structure, or any other method for communicating data.

One or more communication unit(s) 220 communicate with external devices via one or more wired and/or wireless networks by transmitting and/or receiving network signals on the one or more networks. Examples of communication unit(s) 220 include a network interface card (e.g., an Ethernet card), an optical transceiver, a radio frequency transceiver, a GPS receiver, or any other type of device that can send and/or receive information. Other examples of communication unit(s) 220 may include short wave radios, cellular data radios, wireless network radios, as well as universal serial bus (USB) controllers.

One or more sensor(s) 250 may receive input. Examples of sensor(s) 250 include, but are not limited to, a capacitive touchscreen, a projective capacitive touchscreen, a resistive touchscreen, a surface acoustic wave touchscreen, a camera, a microphone, a button, a switch, an accelerometer, a gyroscope, a barometer, a magnetometer, a radar, etc. Sensor(s) 250 may receive input, such as radio wave input, in conjunction with communication unit(s) 220 (e.g., a UWB interface, a personal area network (PAN) interface, a global positioning system (GPS) receiver, a radar detector, etc.).

One or more storage component(s) 240 store information for processing during operation of computing device 200. In some examples, storage component(s) 240 is a temporary memory, meaning that a primary purpose of storage component(s) 240 is not long-term storage. Storage component(s) 240 on computing device 200 may be configured for short-term storage of information as volatile memory and therefore may not retain stored contents if powered off. Examples of volatile memories include random-access memories (RAM), dynamic random-access memories (DRAM), static random-access memories (SRAM), and other forms of volatile memories known in the art.

Storage component(s) 240, in some examples, also include one or more computer-readable storage media. Storage component(s) 240, in some examples, include one or more non-transitory computer-readable storage mediums. Storage component(s) 240 may be configured to store larger amounts of information than typically stored by volatile memory. Storage component(s) 240 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage component(s) 240 may store program instructions and/or information (e.g., data) associated with input detection unit 242, status change monitoring unit 244, notification determination unit 246, display interface unit 248, and VN 260.

One or more processors 210 may implement functionality and/or execute instructions associated with computing device 200. Examples of processors 210 include application processors, display controllers, auxiliary processors, one or more sensor hubs, and any other hardware configured to function as a processor, a processing unit, or a processing device. Input detection unit 242, status change monitoring unit 244, notification determination unit 246, and display interface unit 248 may include instructions that are operable by processors 210 to perform various actions, operations, or functions of computing device 200. For example, processors 210 may retrieve and execute instructions stored by storage component(s) 240 that cause processors 210 to perform the operations described herein that are attributed to input detection unit 242, status change monitoring unit 244, notification determination unit 246, and display interface unit 248. The instructions, when executed by processors 210, may cause computing device 200 to store information within storage component(s) 240, for example, at VN 260.

While displayed as part of a single device in the example of FIG. 2, components of computing device 200 may, in some examples, be located within and/or as part of different devices. For instance, in some examples, some of or all the functionality of input detection unit 242, status change monitoring unit 244, notification determination unit 246, and display interface unit 248 may be located at the same or different computing systems. That is, in some examples, techniques of the present disclosure may be performed and utilized by a single computing device, while, in other examples, the techniques may be performed and/or utilized across a plurality of computing systems, such as a distributed or “cloud” computing system.

Computing device 200 may include a display with a first portion and a second portion. Perimeter display 280 may represent the first portion, which may include a substantial portion of a perimeter of display 265 (such as a contiguous band of pixels that surrounds more than 50% or some higher percentage of the perimeter of the display, where the band may be a number of pixels wide but less than some percentage of the overall pixels of the display, e.g., 1%, 5%, 10%, 20% or 30%—or possibly higher percentages but below 50%—of all the available pixels of the display), while central display 270 may represent the second portion of display 265. Central display 270 may not include perimeter display 280. Perimeter display 280 may represent an example of perimeter display 118 of FIG. 1, while central display 270 may represent an example of central display 116 of FIG. 1. Computing device 200 may interface with perimeter display 280 to Output a pattern of light that reflects one or more of VN 260 indicative of a status change of computing device 200.

In operation, status change monitoring unit 244 may first determine a change in the status of computing device 200. A status change may occur responsive to many different conditions. For example, computing device 200 may be configured to periodically or contextually (e.g., when connected to a particular wireless network, when at a certain location as indicated by a GPS sensor, etc.) scan the environment (e.g., to detect a user via radar or other proximity sensors), network (either wireless networks, including PANs, cellular networks, and the like) or other medium, thereby activating various sensors or interfaces to identify remote device 130, a user or other activity in the environment, network, or other medium. Rather than silently activate the sensors or other interfaces to perform the scan without alerting the user, status change monitoring unit 244 may detect the change in status of computing device 200 (which may include a change of status to one of sensors 250, communication unit(s) 220, processors 210, etc.) and interface with notification determination unit 246 to provide an indication representative of the change of status.

Further, computing device 200 may change status as a result of input from a user or another device, e.g., a companion device, such as a smartwatch, smart glasses, smart speaker, home hub, etc. Remote device 130 may represent one example of such a companion device. In any event, input detection unit 242 may detect inputs from the user provided via central display 270 (when central display 270 represents a presence sensitive display capable of receiving touch inputs), buttons or other sensors 250, including motion input detected by a gyroscope and/or accelerometer, weather inputs sensed by a weather sensor of sensors 250 (such as humidity, barometric pressure, temperature, wind speed, etc.), GPS input representative of a location of computing device 200, and the like.

In other words, input detection unit 242 may receive indication of the input from communication unit(s) 220 and/or sensor(s) 250. Input detection unit 242 may receive indication of a tactile input, an auditory input, a visual input, a touchless gesture input, a motion input, or a secondary device input. Sensor(s) 250 may receive a button press, a single-touch gesture, or a multi-touch gesture. Sensor(s) 250 may identify a voice command to a voice assistant or a keyword (e.g. “Computer,” etc.). Sensor(s) 250 may receive a QR code or a picture key (e.g., facial recognition). Communication unit(s) 220 and/or sensor(s) 250 may detect a reach for computing device 200 or a wave at computing device 200. Communication unit(s) 220 and/or sensor(s) 250 may detect (e.g., via a gyroscope) a physical movement of computing device 200, such as lifting or turning of computing device 200. Communication unit(s) 220 and/or sensor(s) 250 may receive an input from a secondary device, such as a signal of a wired connection, a UWB signal, a Bluetooth® signal, or a WiFi™ signal. In response to communication unit(s) 220 and/or sensor(s) 250 via communication channel(s) 230 detecting the input, input detection unit 242 may then receive an indication of the input.

Such user inputs and sensor inputs may result in the change of status of computing device 200, whereby computing device 200 may independently perform some operation responsive to the change in status. Rather than silently perform these operations, input detection unit 242 may interface with status change monitoring unit 244 to provide an indication of the input, whereby the status change monitoring unit 244 may determine the change in status based on the indication of the input. Status change monitoring unit 244 may then provide an indication representative of the change of status to notification determination unit 246.

In some examples, software installed on computing device 200 may respond to the input and initiate activity on computing device 200 according to respective instructions of the software. For example, in response to a button tap on a touchscreen, a camera app may activate a camera from sensor(s) 250 to take a picture. As another example, in response to a wave gesture, an alarm app may snooze an alarm. As yet another example, in response to a press of a button of sensor(s) 250, a volume controller may increase or decrease the volume of computing device 200. As yet another example, in response to a UWB signal received by communication unit(s) 220, a remote device pairing controller may discover a second computing device (e.g., remote device 130).

Status change monitoring unit 244 may determine a change in status due to software on computing device 200 altering a performance mode of computing device 200. For example, due to radio waves transmitted from a remote device (e.g., remote device 130), computing device 200 may enter a paired mode, where the change in status includes computing device 200 pairing, via a personal area network or a UWB connection, with the remote device. As another example, due to a tap on a button on a touch screen, computing device 200 may enter a recording mode, where computing device 200 receives, stores, and/or analyzes input to the microphone. As yet another example, due to a user lifting computing device 200, computing device 200 may enter a discovery mode, in which computing device 200 indicates a functionality of computing device 200, such as a button available for pressing or a microphone available for speaking into.

In other cases, status change monitoring unit 244 may analyze activity on computing device 200 and determine a significant status change. Status change monitoring unit 244 may determine the significance of the status change based on distinguishing characteristics of the activity. Status change monitoring unit 244 may analyze an activation of a noteworthy hardware of computing device 200 (e.g., a camera or a microphone in sensor(s) 250, a radio wave receiver and/or transmitter in communication unit(s) 220, etc.). Status change monitoring unit 244 may analyze a change in a value within a range (e.g., an audio volume, a screen brightness, etc. Status change monitoring unit 244 may, in this case, provide an indication of the change of status to notification determination unit 246.

Notification determination unit 246 may receive the indication representative of the change of status. Notification determination unit 246 may, based on the change of status, select one of VN 260, which represent a pattern of pixel activations to indicate the status change. Notification determination unit 246 may interface with display interface unit 248, providing an indication of the selected one of VN 260. Based on the indication of the selected one of VN 260, display interface unit 248 may interface with perimeter display 280 to configure perimeter display 280 to activate the pixels denoted by the one of VNs 260 selected by notification determination unit 246 and thereby output the pattern of light.

Based on the status change, notification determination unit 246 may determine a visual notification to communicate the status change to the user. Notification determination unit 246 may determine a significance of the status change of computing device 200. Notification determination unit 246 may determine the significance by predicting whether the user's knowledge of the status change would produce a change in action by the user. For example, notification determination unit 246 may calculate a utility score for the status change and determine that the status change is significant if the utility score meets a threshold utility score. In some cases, notification determination unit 246 may determine that the status change will cause the user to engage in a new action (e.g., begin streaming music to a newly paired remote device, discover a new functionality of controls on computing device 200, etc.), resulting in a higher utility score. In other cases, notification determination unit 246 may determine that the status change may cause the user to stop engaging in an action (e.g., discontinuing an increase of the volume or releasing a button in a camera app), resulting in a higher utility score.

In some cases, notification determination unit 246 may receive a data object from a software application indicating the significance of a status change caused by the software application. In other words, the software application may be configured to provide an indication that identifies one of VN 260. For example, a camera app may identify capturing an image as a significant status change, providing an indication to status change monitoring unit 244 that identifies one of VN 260 associated with activating the camera to capture an image (and/or video). As another example, a motion sensor controller may predict that a user has picked up computing device 200 to speak into the microphone and may identify the future use of the microphone as a significant status change, providing an indication identifying one of VN 260 associated with activation of the microphone.

Notification determination unit 246 may determine that the significance (as measured by the utility score) of a status change merits presentation of one of VN 260. After determining that a significant status change will result in selection of one of VN 260, notification determination unit 246 may further select the one of VN 260.

Notification determination unit 246 may also, in some examples, determine features of the status change to select one of VN 260. Features may include a direction corresponding to the status change. The status change may include features that correspond to a hardware on computing device 200, such as a sensor or a button. The status change may include features that correspond to a remote device or a touchless gesture with a known location relative to computing device 200. Features may include an intensity corresponding to the status change. In some examples, the status change may include features that correspond to a volume range or a distance between a remote device and computing device 200. Alternatively, notification determination unit 246 may determine that the status change has no significant features, such as directionality or intensity.

In examples where notification determination unit 246 determines a directionality of the status change, notification determination unit 246 may select one of VN 260 representative of a pattern of pixel activations that includes variations indicating the directionality of the status change. For instance, the selected one of VN 260 may specify activation of a first group of pixels and inactivation of a second group of pixels (of perimeter display 280), activation of a group of pixels with an output of higher intensity than another group of pixels (of perimeter display 280), or activation of a group of active pixels with an output of a different color than another group of pixels (of perimeter display 280). The arrangement of the distinct groups of pixels may indicate a location of a sensor or another input mechanism corresponding to the status change. For example, if input detection unit 242 receives indication of a button press that initiates a volume increase or decrease, notification determination unit 246 may select one of VN 260 that specifies a position of a group of pixels that aligns with the button. As another example, if computing device 200 is recording a microphone input, notification determination unit 246 may select one of VN 260 that activates the group of pixels in a location on perimeter display 280 that align with the microphone.

In examples where computing device 200 is informing the user of a functionality provided by computing device 200, notification determination unit 246 may select one of VN 260 that activates a distinct group of pixels that align with a mechanism associated with the functionality on computing device 200. In such cases, notification determination unit 246 may select one of VN 260 that activates an arrangement of pixels such that the pattern of pixels indicates an ability of computing device 200 to receive an additional input. For example, notification determination unit 246 may select one of VN 260 that activates a pattern of pixels that includes a group of pixels aligned with a power button to indicate that the power button opens a relevant application, e.g., such as a camera application. In some instances, notification determination unit 246 may select one of VN 260 that activates the group of pixels such that the group of pixels outputs two pulses, which, when presented, indicates that interacting with the power button through two presses may open the relevant application, e.g., the camera application.

Notification determination unit 246 may select one of VN 260 that activates an arrangement of pixels of perimeter display 280 to indicate a direction of a remote input, such as from remote device 130 or a touchless gesture, relative to computing device 200. In a case where computing device 200 pairs with a remote device, the positioning of the distinct group of pixels may align with the direction of the remote device relative to computing device 200, indicating the direction of the remote device relative to computing device 200. In a case where computing device 200 silences a notification signal in response to a waving gesture, notification determination unit 246 may select one of VN 260 that activates a distinct group of pixels to align with the direction of the wave relative to computing device 200. Additionally or alternatively, notification determination unit 246 may determine other variations in the groups of pixels to indicate other status changes, and modify or otherwise alter an existing one of VN 260 (which may serve as a template that notification determination unit 246 may modify to create a new VN).

In other examples, notification determination unit 246 may select one of VN 260 that activates a pattern of pixels that includes one distinct group, without variation. For example, the pattern may include one level of brightness and one color. In such examples, notification determination unit 246 may determine that the status change does not correspond to a relevant direction or position.

Notification determination unit 246 may select one of VN 260 that indicates a group of pixels should encompass the entire portion of perimeter display 280. Notification determination unit 246 may select one of VN 260 representative of such a pattern in response to a status change indicating that a camera of computing device 200 is activated for purposes of taking a picture or video, that computing device 200 is capturing a screenshot, and/or that computing device 200 unlocks.

Notification determination unit 246 may select one of VN 260 representative of a pattern of pixels representative of perimeter display 280 with animation. Notification determination unit 246 may select one of VN 260 representative of a dynamic time series of activations (e.g., an activation followed by a deactivation, a change in color or intensity of an activated pixel, a change after a delay compared to other pixel changes, etc.) as the animation. Notification determination unit 246 may select one of VN 260 representative of a change in activation of a whole group of pixels, such as by an activation, deactivation, and reactivation of the group of pixels.

In effect, the change in activations may appear, when output on perimeter display 280, as a flash or pulse of pixels. Notification determination unit 246 may select one of VN 260 representative of a change in a number of pixels in a group of pixels over time, such that the group of pixels of perimeter display 280 includes more activated pixels over time or the group of pixels of perimeter display 280 includes fewer activated pixels over time.

In effect, the change in the number of pixels in a group of pixels of perimeter display 280 may appear, when activated by perimeter display 280, as a growing or shrinking group of pixels. The animation may correspond to the status change. For example, a group of pixels may flash on and off to attract the attention of the user, such as when computing device 200 is suggesting a functionality of computing device 200. As another example, the pattern of pixel activations may, blink to help a user discover a functionality, such as an activation, deactivation, and reactivation of a group of pixels next to a power button to, for example, indicate that a double-click will launch the camera application.

In some cases, notification determination unit 246 may select one of VN 260 representative of a size of groups of activated pixels proportional to a magnitude corresponding to the status change. Notification determination unit 246 may adapt the selected one of VN 260 to change the size in proportion to a changing magnitude. Notification determination unit 246 may change the size of the group of pixels by activating or deactivating some pixels after a delay compared to other pixels of the group of pixels.

In some examples, the animation may include a group of pixels changing the intensity or color of the output. For example, a distinct group of pixels (e.g., distinct by activation compared to inactive pixels, or distinct by brightness or color compared to other activated pixels, etc.) corresponding to a volume change may grow in size as the volume increases and may shrink in size as the volume decreases, where such pixels correspond to discrete pixels represented by the perimeter display 280.

As another example, a distinct group of pixels indicating a remote device, such as remote device 130 shown in the example of FIG. 1, may change in size in proportion to the proximity of computing device 110 to remote device 130, growing (e.g., adding activated pixels, etc.) as remote device 130 approaches computing device 110 and shrinking (e.g., deactivating some pixels, etc.) as remote device 130 withdraws from computing device 110. Additionally or alternatively, notification determination unit 246 may determine other animations of the pattern of pixels to indicate other status changes.

In some cases, notification determination unit 246 may construct the pattern representative of the status change. In other cases, notification determination unit 246 may use a pattern indicated by a software application associated with the status change, such as by the software application providing a data object to notification determination unit 246. In yet other cases, notification determination unit 246 may use a pattern stored in computing device 200 as VN 260. A pattern indicated by a software application or from VN 260 may specify one or more intensities, one or more colors, one or more directions, and/or one or more animations. A pattern of VN 260 may indicate a status change or a characteristic of a status change such that when notification determination unit 246 detects the status change, notification determination unit 246 may refer to a corresponding pattern in VN 260.

A user of computing device 200 may customize patterns via a user interface. Notification determination unit 246 may store the customized patterns as VN 260. A customization may include an intensity, a color, and/or an animation. Notification determination unit 246 may provide default values that the user may change. The user may further customize the type of status change for which notification determination unit 246 determines a pattern. For example, notification determination unit 246 may select and adapt one of VN 260 representative of feedback or a discoverability mode only when computing device 200 is configured to provide feedback or discoverability, such as when indicated by a user in a settings configuration or as a default configuration.

After notification determination unit 246 selects one of VN 260, display interface unit 248 may interface with perimeter display 280 to output, based on the selected one of VN 260, the visual notification as a pattern of light. Display interface unit 248 may execute the pixel activations identified by the one of VN 260 determined by notification determination unit 246. Notification determination unit 246 may determine the one of VN 260 representative of the pattern of light and provide an indication of the determined one of VN 260 to display interface unit 248.

Display interface unit 248 may represent a unit configured to interface with perimeter display 280 and/or central display 270. Display interface unit 248, responsive to receiving the determined one of VN 260, may configure perimeter display 280 (and not central display 270) to output the pattern of light represented by the determined one of VN 260. In other words, display interface unit 248 may configure a display buffer, which may be separate from a display buffer for central display 270 (or integrated within the display buffer for central display 270) to store various values that result in activation of pixels in a manner that outputs the pattern of light represented by the determined one of VN 260.

As such, perimeter display 280 may include a display buffer separate from the central display, or both perimeter display 280 and central display 270 may share a common display buffer. When the display buffer is shared, display interface unit 248 may store the data to the shared buffer using a common interface, but the display processor may copy the contents of the display buffer that activates pixels of central display 270, and replace the data that activates the pixels of perimeter display 280 with the data provided by display interface unit 248, thereby only changing (in some instances) output of patterns of light at perimeter display 280. The separate display buffers for each of central display 270 and perimeter display 280 may avoid such copying of the data stored for central display 270, potentially improving performance, but increasing costs associated with separate buffers.

In some cases, computing device 200 may include two display processors to process instructions for perimeter display 280 and central display 270, respectively. In other cases, computing device 200 may include a single display processor with two distinct frame buffers for perimeter display 280 and central display 270, respectively. In some cases, computing device 200 may include a single frame buffer logically divided into two parts.

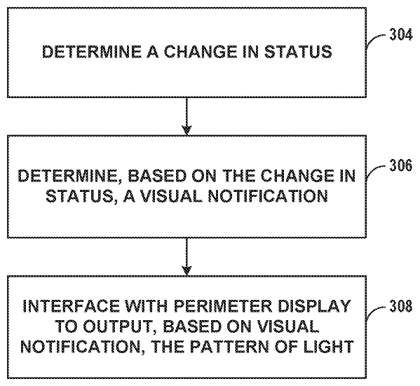

FIG. 3 is a flow diagram illustrating example operations of a computing device for providing visual communication via edge lighting, in accordance with one or more aspects of the present disclosure. For purposes of illustration only, the example operations of FIG. 3 are described below within the context of FIG. 2.

In the example of FIG. 3, computing device 200 includes a display 265 with a first portion (i.e., perimeter display 280 in the example of FIG. 2) and a second portion (i.e., central display 270 in the example of FIG. 2). The first portion includes only a perimeter of the display 265, and the second portion excludes the perimeter of display 265. That is, the first portion substantially encompasses the second portion (such as a contiguous band of pixels that surrounds more than 50% or some higher percentage of the perimeter of the display, where the band may be a number of pixels wide but less than some percentage of the overall pixels of the display, e.g., 1%, 5%, 10%, 20% or 30%—or possibly higher percentages but below 50%—of all the available pixels of the display).

In some cases, the first portion and the second portion are two parts of one display. In other cases, the first portion and the second portion are separate displays. The first portion may be any of various widths (e.g., 1, 2, . . . 20 pixels, etc.). In some examples, the first portion and the second portion may be on an equal plane (e.g., the first portion and the second portion may be on a frontal face of the computing device). In other examples, the first portion and the second portion may be arranged at different non-zero angles to one another. The second portion may be on a frontal face of the computing device, while the first portion may be on an edge of the computing device (e.g., the first portion may be at a non-zero angle relative to the second portion).

Computing device 200 may detect an input. Computing device 200 may detect the input with any of a variety of sensors and/or communication devices (e.g., a presence-sensitive touchscreen, a microphone, a camera, an accelerometer, a radar, etc. such as via communication unit(s) 220, sensors 250, and/or display 265. In some examples, the input may be tactile, such as a single touch or a multi-touch on a touchscreen (which display 265 may represent when configured to perform presence-sensitive detection) of computing device 200 or a press of a button on the computing device. In other examples, the input may be auditory, such as a voice command. In yet other examples, the input may be visual, such as a QR code. In yet other examples, the input may be a movement of the computing device, such as lifting or flipping the computing device. In yet other examples, the input may be a radio wave transmission, such as a touchless gesture (e.g., a wave) or a signal from another computing device (e.g., a UWB signal).

Computing device 200 may determine a change in a status of the computing device (304), which may be responsive to the input as discussed above. The change in status may be, for example, an execution of an operation or an alteration of a performance mode. For example, computing device 200 may unlock the second portion of the display in response to a visual password presented via the camera (e.g., using facial recognition). As another example, computing device 200 may enter a paired mode with remote device 130 (shown in the example of FIG. 1) in response to receiving a PAN signal.

Based on the change in the status, computing device 200 may determine a visual notification 260 representative of the above described pattern of light (306). The visual notification 260 may indicate activation of pixels of perimeter display 280 that outputs the pattern of light. Visual notification 260 may represent data indicative of activation of one or more groups of pixels of varying size or with output of varying brightness or color. In some cases, the selected one of visual notifications 260 may include data indicative of activation of a single group of pixels, without variation. In other cases, the selected one of visual notifications 260 may include data indicative of activation of two or more groups, distinguishable by different brightness or different colors. The selected one of visual notifications 260 may include data indicative of activation of pixels output an animated pattern of light, such as by blinking or changing a size of a group of pixels over time.

Computing device 200 may emphasize characteristics of the change of the status in the pattern. The change in the status may include a direction, such as of remote device 130 or of a hardware component of computing device 200 (e.g., a microphone, a button, etc.). In such an example, the selected one of visual notifications 260 may include data indicative of activation of two or more distinct groups of pixels, with a group aligning with the direction. The selected one of visual notifications 260 may include data indicative of an intensity, such as an audio volume or a proximity to a remote device. The selected one of visual notifications 260 may include data indicative of activation of two or more distinct groups of pixels, with a size of the group corresponding to the intensity. Moreover, the selected one of visual notifications 260 may include data indicative of activation of pixels that result in an animation, such that a number of the groups of activated pixels grow or shrink respective to the increasing or decreasing intensities or proximity of computing device 200 relative to remote device 130.

The pattern may, in this respect, provide visual communication to the user. The pattern may confirm to the user that the computing device is processing the input. For example, the pattern may indicate a direction of a remote gesture, such as a wave by the user, confirming to the user that computing device 200 detected the gesture. The pattern may suggest an action to the user. For example, the pattern may indicate (e.g., via an activation, deactivation, and reactivation of a group of pixels aligned with the power button of the computing device) that the user may take a picture by double-pressing the power button.

Computing device 200 may invoke display interface unit 248 to interface with perimeter display 280 to output, based on the selected one of visual notifications 260, the pattern of light (308). Perimeter display 280 may perform the pixel activations according to the selected one of visual notifications 260, producing a corresponding pattern of light. Perimeter display 280 may thereby output the pattern of light. By displaying the pattern of light via perimeter display 280, computing device 200 may indicate to the user a 360-degree situational awareness of the environment. The time duration of the pattern of light may be any of a variety of durations (e.g., a half second, one second, two seconds, etc.)

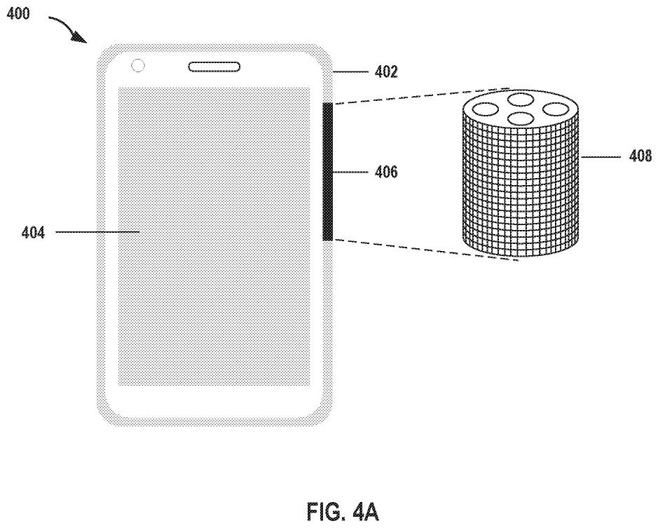

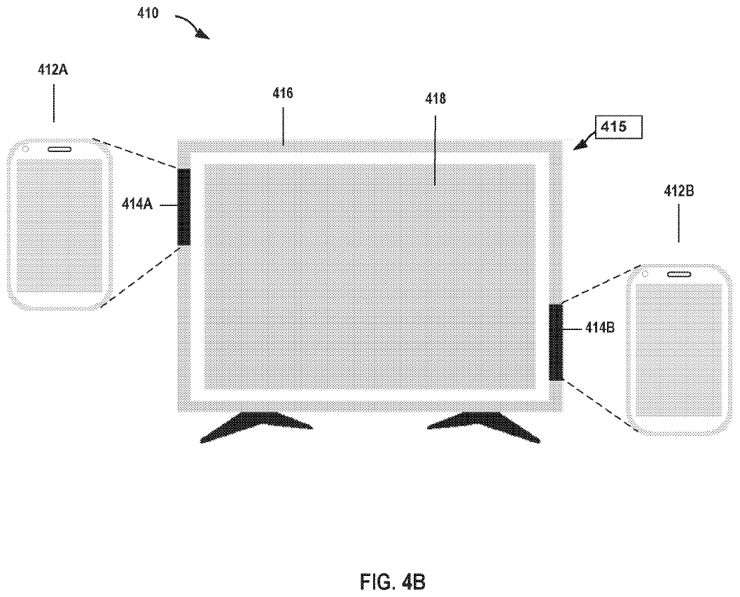

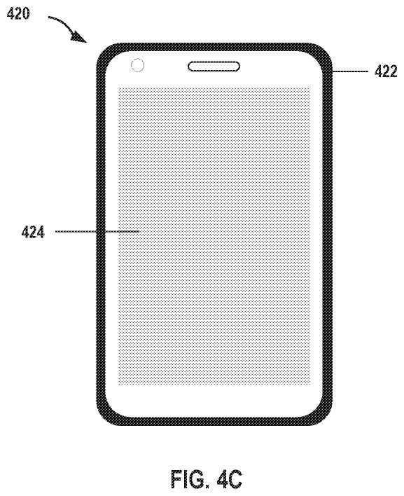

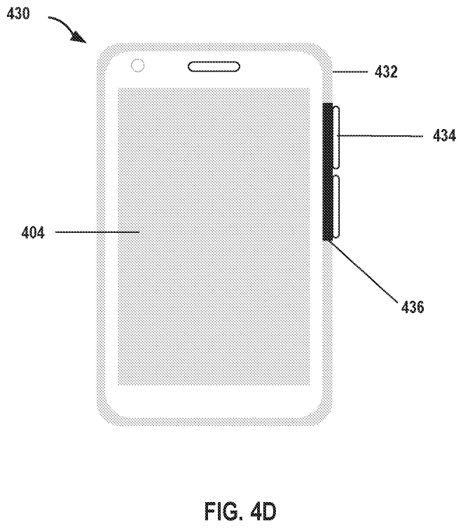

FIGS. 4A through 4D are conceptual diagrams illustrating example computing devices for providing visual communication via edge lighting, in accordance with various techniques of this disclosure.

FIG. 4A shows example scenario 400 with smartphone 404 including a central display and perimeter display 402, where smartphone 404 may represent one example of computing device 200 shown in the example of FIG. 2. Smartphone 404 has detected, in the example of FIG. 4A, remote speaker 408, such as via a PAN or UWB signal, where remote speaker 408 represents one example of remote device 130. Smartphone 404 communicates the presence of remote speaker 408 to a user by producing, on perimeter display 402, a pattern of light.

That is, smartphone 404 may determine, responsive to detecting remote speaker 408 that smartphone 404 has changed status in terms of having the ability to communicate with a remote device, which in this example is represented by remote speaker 408. As such, smartphone 404 may select, based on the change of status, one of VN 260. Smartphone 404 may interface with perimeter display 402 to present, via the activated portion 406 and based on the selected one of VN 260, the pattern of light.

The pattern of light indicates the direction of remote speaker 408 relative to smartphone 404 by outputting a segment of light via portion 406 of perimeter display 402, distinct from the rest of perimeter display 402, in a position corresponding to the direction of remote speaker 408. Portion 406 may be distinct from the rest of perimeter display 402 as a result of outputting a different brightness or color. In some cases, smartphone 404 may interface with perimeter display 402 to animate the segment of light output by portion 406 and thereby indicate a change in proximity with remote speaker 408. For example, portion of 406 may grow in size (in terms of a number of activated pixels included in portion 406 relative to a number of pixels previously in the activated number of pixels included in portion 406) as smartphone 404 approaches remote speaker 408 and may decrease (in terms of a number of activated pixels included in the portion 406 relative to a number of pixels previously in the activated number of pixels included in portion 406) as smartphone 404 withdraws from remote speaker 408.

FIG. 4B shows example scenario 410 with smart TV 415 including a central display 418 and perimeter display 416, where smart TV 418 represents another example of computing device 200 shown in the example of FIG. 2. Smart TV 415 detects remote control 412A and remote control 412B (collectively, “remote controls 412”), such as via PAN or UWB signal, where remote controls 412 each represent an example of remote device 130 shown in the example of FIG. 1. Detection of such remote controls 412 may result in smart TV 418 detecting a change in status of smart TV 415, whereupon smart TV 415 may select one of VN 260.

Smart TV 415 communicates the presence of remote controls 412 to a user by producing, via perimeter display 416, a pattern of light. As such, smart TV 415 may invoke display interface unit 248 to interface with perimeter display 416 to output, based on the selected one of VN 260, the pattern of light represented by the selected one of VN 260. The pattern of light indicates the respective directions of remote controls 412 relative to smart TV 415 by activating portions 414A and 414B of perimeter display 416 to present a segment of light in positions respective to the directions of remote controls 412.

Portions 414A and 414B (“portions 414”) are distinct from the rest of perimeter display 416, due to portions 414 producing a different brightness or color. In some cases, portions 414 may output animated segments of light to indicate a change in proximity with remote controls 412. For example, portion 414A may output a segment of light that grows in size as remote control 412A approaches smart TV 415. As another example, portion 414B may output a segment of light that may decrease in size as remote control 412B withdraws from smart TV 418.

FIG. 4C shows example smartphone 420 including central display 424 and perimeter display 422, where smartphone 420 may represent one example of computing device 200 shown in the example of FIG. 2. Smartphone 420 detects input from a user, such as a touch on a touchscreen of central display 424 or a facial recognition via a camera of smartphone 420. Smartphone 420 may determine that a status change in response to the touch or to the facial recognition does not correspond to a particular direction but still merits visual communication to the user.

Smartphone 420 may determine, based on the detected change of status—which refers to detection of the user input—one of VNs 260 that corresponds to the detected change of status. Smartphone 420 may configure, based on the determined one of VNs 260, perimeter display 422 to produce a pattern of light having a single segment of light without variation (i.e., of a uniform brightness and color). In this way, smartphone 420 may communicate to the user that smartphone 420 has received and is processing the input.

Smartphone 420 may configure perimeter display 422 to produce the pattern of light regardless of additional content displayed on central display 424. In some cases, perimeter display may be configured to produce the pattern of light in case of a delay in producing content on central display 424. In other cases, perimeter display 422 may be configured to produce the pattern of light to standardize the visual communication to the user across all apps installed on smartphone 420.

FIG. 4D shows example smartphone 430 including a central display and perimeter display 432, where smartphone 430 represents another example of computing device 200 shown in the example of FIG. 2. Smartphone 430 detects a button press by a user on volume control button 434. In response to the button press, smartphone 430 may determine a change in status as a change in the volume for audio output by smartphone 430. Smartphone 430 may next select, based on the detected change in status, one of VN 260.

Smartphone 430 communicates the volume change to the user by interfacing with perimeter display 432 to output, based on the selected one of VN 260 and via portion 436 of perimeter display 432, a pattern of light. The pattern of light indicates the location of volume control button 434 on smartphone 430 by aligning the pattern of light with volume control button 434. The segment of light output is distinct from the rest of the light output by perimeter display 432 due to, as one example, a different brightness or color. Smartphone 430 may configure perimeter display 432 to animate the segment of light output by portion 436 to indicate a change in volume. For example, portion of 436 may grow in size (in terms of a number of activated pixels included in portion 436 relative to a number of pixels previously in the activated number of pixels included in portion 436) as the volume increases and may decrease (in terms of a number of activated pixels included in the portion 436 relative to a number of pixels previously in the activated number of pixels included in portion 436) as the volume decreases, thereby indicating to the user the change in the volume of smartphone 430.

In this way, various aspects of the techniques may enable the following clauses.
Clause 1. A method comprising: determining, by one or more processors of a computing device, a change in a status of the computing device; determining, by the one or more processors of the computing device and based on the change in the status, a visual notification; and interfacing, by the one or more processors of the computing device, with a first portion of a display of the computing device to output, based on the visual notification, a pattern of light, the display including the first portion and a second portion, the first portion including a substantial portion of a perimeter of the display, and excluding the second portion of the display.
Clause 2. The method of clause 1, further comprising detecting a user input, wherein determining the change in the status Of the computing device comprises determining, based on the user input, the change in the status of the computing device.
Clause 3. The method of any combination of clauses 1 and 2, further comprising detecting that a wireless connection to a different device is available, wherein determining the change in the status comprises determining that the wireless connection to the different device is available.
Clause 4. The method of clause 3, further comprising determining a direction of the different device relative to the computing device, wherein determining the visual notification includes determining a directional visual notification that indicates the direction of the different device relative to the computing device, and wherein interfacing with the first portion of the display comprises interfacing with the first portion of the display to output, based on the directional visual notification, the pattern of light to indicate the direction of the different device relative to the computing device.
Clause 5. The method of clause 3, wherein the directional visual notification includes a proximity visual notification that indicates a relative distance between the different device and the computing device.
Clause 6. The method of any combination of clauses 1-5, wherein the sensor visual notification indicates the status change of a sensor of the computing device, and wherein interfacing with the first portion of the display comprises interfacing with the first portion of the display to output, based on the sensor visual notification, the pattern of light to indicate a location of the sensor at the computing device.
Clause 7. The method of clause 6, wherein the sensor includes one or more of a camera and a microphone.
Clause 8. The method of any combination of clauses 1-7, wherein the first portion of the display is a first display and the second portion of the display is a second display distinct from the first display.
Clause 9. The method of any combination of clauses 1-8, wherein the visual indication indicates that the computing device is configured to accept a user input.
Clause 10. The method of any combination of clauses 1-9, wherein the first portion of the display is positioned at a non-zero angle relative to the second portion of the display.
Clause 11. A computing device comprising: a display including a first portion and a second portion, wherein the first portion includes a substantial portion of a perimeter of the display and excludes the second portion of the display; one or more processors configured to: determine a change in a status of the computing device; determine, based on the change in the status, a visual notification; and interface with the first portion of the display to output, based on the visual notification, a pattern of light.
Clause 12. The computing device of clause 11, wherein the one or more processors are further configured to detect a user input, and wherein the one or more processors are configured to determine, based on the user input, the change in the status of the computing device.
Clause 13. The computing device of any combination of clauses 11 and 12, wherein the one or more processors are further configured to detect that a wireless connection to a different device is available, and wherein the one or more processors are configured to determine that the wireless connection to the different device is available.
Clause 14. The computing device of clause 13, wherein the one or more processors are further configured to determine a direction of the different device relative to the computing device, wherein the one or more processors are configured to: determine a directional visual notification that indicates the direction of the different device relative to the computing device; and interface with the first portion of the display to output, based on the directional visual notification, the pattern of light to indicate the direction of the different device relative to the computing device.
Clause 15. The computing device of clause 13, wherein the directional visual notification includes a proximity visual notification that indicates a relative distance between the different device and the computing device.
Clause 16. The computing device any combination of clauses 11-15, wherein the sensor visual notification indicates the status change of a sensor of the computing device, and wherein the one or more processors are configured to interface with the first portion of the display to output, based on the sensor visual notification, the pattern of light to indicate a location of the sensor at the computing device.
Clause 17. The computing device of clause 16, wherein the sensor includes one or more of a camera and a microphone.
Clause 18. The computing device of any combination of clauses 11-17, wherein the first portion of the display is a first display and the second portion of the display is a second display distinct from the first display.
Clause 19. The computing device of any combination of clauses 11-18, wherein the visual indication indicates that the computing device is configured to accept a user input.
Clause 20. The computing device of any combination of clauses 11-19, wherein the first portion of the display is positioned at a non-zero angle relative to the second portion of the display.
Clause 21. A non-transitory computer-readable storage medium having stored thereon instructions that, when executed, cause one or more processors to: determine a change in a status of the computing device; determine, based on the change in the status, a visual notification; and interface with a first portion of a display of the computing device to output, based on the visual notification, a pattern of light, the display including the first portion and a second portion, the first portion including a substantial portion of a perimeter of the display and excluding the second portion of the display.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed:

1. A method comprising:
determining, by one or more processors of a computing device, a change in a status of the computing device;
determining, by the one or more processors of the computing device and based on the change in the status, a visual notification; and
interfacing, by the one or more processors of the computing device, with a first portion of a display of the computing device to output, based on the visual notification, a pattern of light, the display including the first portion and a second portion, the first portion including a substantial portion of a perimeter of the display, and excluding the second portion of the display.

2. The method of claim 1, further comprising detecting a user input,
wherein determining the change in the status of the computing device comprises determining, based on the user input, the change in the status of the computing device.

3. The method of claim 1, further comprising detecting that a wireless connection to a different device is available,
wherein determining the change in the status comprises determining that the wireless connection to the different device is available.

4. The method of claim 3, further comprising determining a direction of the different device relative to the computing device,
wherein determining the notification includes determining a directional visual notification that indicates the direction of the different device relative to the computing device, and
wherein interfacing with the first portion of the display comprises interfacing with the first portion of the display to output, based on the directional visual notification, the pattern of light to indicate the direction of the different device relative to the computing device.

5. The method of claim 4, wherein the directional visual notification includes a proximity visual notification that indicates a relative distance between the different device and the computing device.

6. The method of claim 1,
wherein the visual notification indicates the status change of a sensor of the computing device, and
wherein interfacing with the first portion of the display comprises interfacing with the first portion of the display to output, based on the visual notification, the pattern of light to indicate a location of the sensor at the computing device.

7. The method of claim 6, wherein the sensor includes one or more of a camera and a microphone.

8. The method of claim 1, wherein the first portion of the display is a first display and the second portion of the display is a second display distinct from the first display.

9. The method of claim 1, wherein the visual notification indicates that the computing device is configured to accept a user input.

10. The method of claim 1, wherein the first portion of the display is positioned at a non-zero angle relative to the second portion of the display.

11. A computing device comprising:
a display including a first portion and a second portion, wherein the first portion includes a substantial portion of a perimeter of the display and excludes the second portion of the display;
one or more processors configured to:
determine a change in a status of the computing device;
determine, based on the change in the status, a visual notification; and
interface with the first portion of the display to output, based on the visual notification, a pattern of light.

12. The computing device of claim 11,
wherein the one or more processors are further configured to detect a user input, and
wherein the one or more processors are configured to determine, based on the user input, the change in the status of the computing device.

13. The computing device of claim 11, wherein the one or more processors are further configured to detect that a wireless connection to a different device is available.

14. The computing device of claim 13,
wherein the one or more processors are further configured to determine a direction of the different device relative to the computing device,
wherein the one or more processors are configured to:
determine a directional visual notification that indicates the direction of the different device relative to the computing device; and
interface with the first portion of the display to output, based on the directional visual notification, the pattern of light to indicate the direction of the different device relative to the computing device.

15. The computing device of claim 14, wherein the directional visual notification includes a proximity visual notification that indicates a relative distance between the different device and the computing device.

16. The computing device of claim 11,
wherein the visual notification indicates the status change of a sensor of the computing device,
wherein the sensor includes one or more of a camera and a microphone, and
wherein the one or more processors are configured to interface with the first portion of the display to output, based on the visual notification, the pattern of light to indicate a location of the sensor at the computing device.

17. The computing device of claim 11, wherein the first portion of the display is a first display and the second portion of the display is a second display distinct from the first display.

18. The computing device of claim 11, wherein the visual notification indicates that the computing device is configured to accept a user input.

19. The computing device of claim 11, wherein the first portion of the display is positioned at a non-zero angle relative to the second portion of the display.

20. A non-transitory computer-readable storage medium having stored thereon instructions that, when executed, cause one or more processors of a computing device to:
determine a change in a status of the computing device;
determine, based on the change in the status, a visual notification; and
interface with a first portion of a display of the computing device to output, based on the visual notification, a pattern of light, the display including the first portion and a second portion, the first portion including a substantial portion of a perimeter of the display and excluding the second portion of the display.
